(19) United States
(12) Patent Application Publication
(10) Pub. No.: US 2021/0133732 A1
(43) Pub. Date: May 6, 2021

(54) SYSTEMS AND METHODS FOR GUEST PAYMENT

(71) Applicant: Walmart Apollo, LLC, Bentonville, AR (US)

(72) Inventors: Natalie I. Alumbaugh, Bella Vista, AR (US); Aditi A. Thakkar, Bentonville, AR (US); Kevin M. Charles, Bentonville, AR (US); Michael S. Stengel, Centerton, AR (US)

(21) Appl. No.: 17/087,083

(22) Filed: Nov. 2, 2020

Related U.S. Application Data
(60) Provisional application No. 62/929,167, filed on Nov. 1, 2019.

(51) Int. Cl. G06Q 20/38; G06Q 20/20; G06Q 40/02; G06Q 20/34; G06Q 20/40; G06Q 20/02; G06F 16/955; H04L 29/06

(52) U.S. Cl. CPC G06Q 20/385; G06Q 20/204; G06Q 40/02; G06Q 20/342; H04L 63/0853; G06Q 20/405; G06Q 20/02; G06F 16/955; G06Q 20/202

(57) ABSTRACT

In some embodiments, apparatuses and methods are provided herein useful to providing guest access to a payment method. In some embodiments, a system for providing guest access to a payment method comprises a user device configured to receive a request from a user to create access to a payment method for a guest and present information to the user, a database configured to store payment method information, unique identifiers, and access numbers, and a control circuit configured to receive the request to create access, transmit verification information, receive a response to the verification information, verify an identity of the user, receive an indication of the guest, generate a unique identifier associated with the payment method, generate an access number transmit the unique identifier, transmit the access number, receive the unique identifier, the access number, and transaction information, determine the payment method, and transmit an indication of the payment method.

### CROSS-REFERENCE TO RELATED APPLICATION

This application claims the benefit of U.S. Provisional Application No. 62/929,167, filed Nov. 1, 2019, which is incorporated by reference in its entirety herein.

### TECHNICAL FIELD

This invention relates generally to retail systems and, more particularly, to processing payments in retail systems.

### BACKGROUND

Cashless payment systems have become ubiquitous as they provide many advantages. Currently, a vast majority of businesses accept credit cards, debit cards, and digital payments (e.g., via a mobile device). Additionally, a number of businesses are now accepting payment in the form of cryptocurrency. However, cashless payment systems have drawbacks. For example, if a person would like someone else to purchase an item on his or her behalf, he or she can simply provide the other person with currency (e.g., cash). This becomes more complicated with a cashless payment. In the same scenario, the person would have to provide his or her credit card, for example, to the other person. Doing so presents risks that providing someone with currency does not. For example, if the credit card falls into the wrong hands, a significant amount of money could be spent via the credit card before the person becomes aware. Consequently, the person may not want to give another person his or her credit card to make a purchase. Accordingly, a need exists for systems, methods, and apparatuses that facilitate guest access to a cashless payment mechanism.

### BRIEF DESCRIPTION OF THE DRAWINGS

Disclosed herein are embodiments of systems, apparatuses and methods pertaining to providing guest access to a payment method. This description includes drawings, wherein:

FIG. 1A depicts an overall process of providing guest access to a payment method, according to some embodiments;

FIG. 1B depicts an overall process of processing a guest payment, according to some embodiments;

FIG. 2 is a block diagram of a system 200 for providing guest access to a payment method, according to some embodiments; and

FIG. 3 is a flow diagram depicting example operation for providing guest access to a payment method, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to providing guest access to a payment method. In some embodiments, a system for providing guest access to a payment method comprises a user device, wherein the user device comprises a user input device, wherein the user input device is configured to receive a request from a user to create access to a payment method for a guest, and a display device, wherein the display device is configured to present information to the user, a database, wherein the database is configured to store payment method information, unique identifiers, and access numbers, and a control circuit, wherein the control circuit is communicatively coupled to the user device and the database, the control circuit configured to receive, from the user device, the request to create access to the payment method, transmit, to the user device for presentation via the display device, verification information, receive, from the user device, a response to the verification information, verify, based on the verification information and the response to the verification information, an identity of the user, receive, from the user device, an indication of the guest, generate, based on the indication of the guest and the payment method, a unique identifier, wherein the unique identifier is associated with the payment method, generate, for the unique identifier, an access number, wherein the access number is required for use of the payment method via the unique identifier, transmit, to a guest device, the unique identifier, wherein the guest device is associated with the guest, transmit, to the user device, the access number, receive, from a point-of-sale device, the unique identifier, the access number, and transaction information, wherein the transaction information is associated with a purchase, determine, based on accessing the database, the payment method associated with the unique identifier, and transmit for payment, an indication of the payment method.

As previously discussed, cashless payment systems offer consumers a wide range of benefits. For example, in cashless payment systems, consumers are not required to physically possess large sums of cash to make large purchases, transaction records are easily attainable, purchases need not be planned in advance, etc. Accordingly, cashless payment systems have become quite common over the years. However, cash payments provide certain advantages. For example, if a parent would like his or her child to make a purchase on his or her behalf, the parent can simply provide his or her child with cash to make the purchase. In this scenario, the risk is only as large as the amount of cash provided. However, even providing cash to another person to make a purchase on your behalf has drawbacks. For example, a person must be physically present to provide cash to another person. Described herein are systems, methods, and apparatuses that seek to minimize, if not eliminate, these drawbacks.

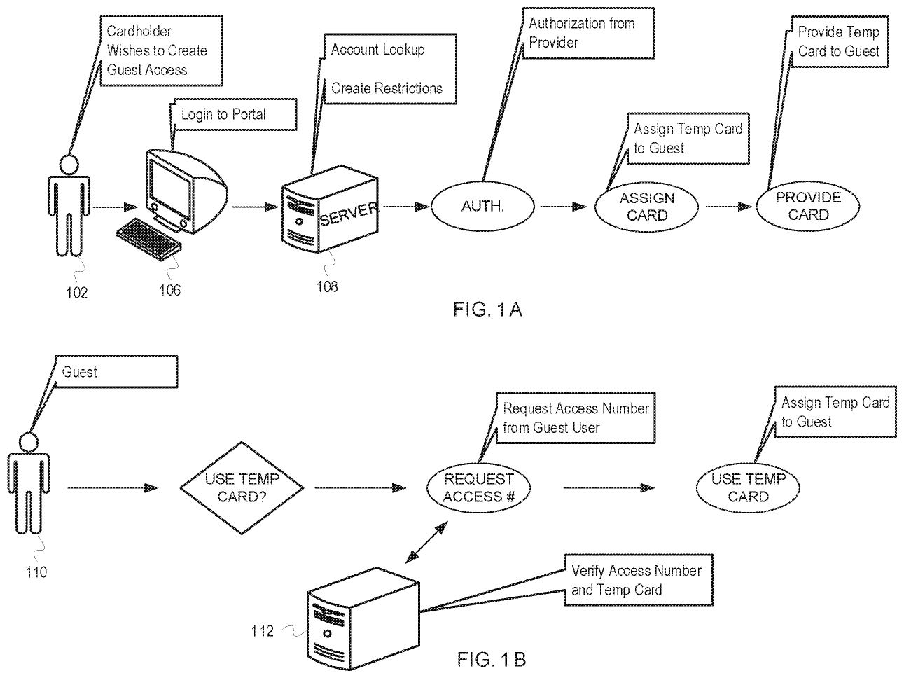

In one embodiment, a system allows a user to create guest access to a payment method (e.g., a credit card, debit card, gift card, electronic payment, etc.). The guest access allows a guest to use the user's payment method as if he or she was in possession of a medium associated with the payment method (e.g., a credit card for a revolving line of credit, a mobile device for a virtual payment method, etc.). To allow such usage, the system creates a unique identifier for the guest to use. The unique identifier is associated with the payment method. The system also creates an access number (e.g., a PIN, code, etc.) that is required to use the unique identifier. When the guest presents the unique identifier and the access number at a point-of-sale (POS) device (e.g., a POS terminal in a retail facility, online via a retailer's website, etc.), the system looks up the payment method using the unique identifier. The system then utilizes the payment method to complete a transaction for the guest. The discussion of FIGS. 1A and 1B provides and overview of such a system.

FIG. 1A depicts an overall process of providing guest access to a payment method, according to some embodiments. The process depicted in FIG. 1A illustrates the creation of a temporary card for a guest. The eligibility for creating guest access can be based on the type of the payment method. It should be noted that the temporary card need not be a physical card. Rather, the temporary card can be any physical or digital medium in which an indication of a unique identifier can be stored. For example, the temporary card can be a physical card including a magnetic stripe and/or radio frequency identification (RFID) tag storing an indication of the unique identifier, a virtual card in a virtual wallet, a unique identifier provided to a guest, etc. A user 102 logs in to a portal to create the guest access. For example, the user 102 can log in to the portal via a computing device 106. The user 102 can log in to the portal (e.g. an online portal) from his or her device (e.g., a computer, smartphone, etc.) and/or in a retail facility (e.g., via an in-store device such as a kiosk located in a retail facility). Additionally, in some embodiments, the user 102 can log in to the portal via a phone call. For example, the user 102 can call a customer service number associated with a retail facility and/or payment method (e.g., a credit card provider) and a customer service representative can log in to the portal on behalf of the user 102. The user 102, or customer service representative, via the portal provides account information to a server 108. The account information allows the server to look up the user's 102 account and create a temporary card.

In some embodiments, the user 102 can create restrictions for the guest access (i.e., restrictions for use of the temporary card). The restrictions can dictate when, where, how, etc. the guest uses the temporary card. For example, the restrictions can limit where the guest can use the temporary card (e.g., types of retail facility, specific retailers, geographic locations, etc.), an amount for which the guest can use the temporary card (e.g., a limit on the price of products, a total cost of a transaction, total cost for a time period, etc.), types of products which the guest can purchase using the temporary card (e.g., grocery items, pharmacy items, etc.), frequency of use of the temporary card by the guest (e.g., once per month, once per week at a specific retailer, etc.), temporality of use of the temporary card by the guest (e.g., the guest access is valid for the two hours, it is valid the first week of the month, etc.), or any other desired restrictions. That is, the restrictions can be based on a transaction amount, a temporality of a transaction, a location of a transaction, items included in a transaction, an occurrence of use of the unique identifier, etc.

After authorization is received from the provider (e.g., a credit card provider, retailer, etc.), the system assigns the temporary card to the guest. In one embodiment, the system assigns the temporary card to the guest by creating a unique identifier for the guest. The unique identifier is associated with the payment method. For example, unique identifiers and payment methods can be stored in a database. In such embodiments, the unique identifier acts as a pointer to the payment method. When the guest presents the temporary card (i.e., the unique identifier) at a point-of-sale device, the systems looks up the payment method based on the unique identifier. The unique identifier is associated with the payment method by the provider (e.g., a financial institution, retailer, etc.). For example, if the provider is a financial institution, such as a credit card provider, the financial institution provides the unique identifier. When the guest presents the unique identifier at a point-of-sale device, the unique identifier is passed to the financial institution for processing of the payment. As another example, if the provider is a retailer, the retailer provides the unique identifier. When the guest presents the unique identifier at the point-of-sale device, the retailer (e.g., a POS terminal or backend system) looks up the payment method associated with the unique identifier and provides an indication of the payment method to, for example, a financial institution for processing of the payment. In such embodiments, the backend (e.g., a control circuit) can verify that the transaction meets the restriction requirements (e.g., whether the items included in the transaction are eligible) before processing the transaction (e.g., transmitting an indication of the payment method).

As previously discussed, the temporary card need not be a physical card. While the temporary card can be a physical card that resembles, for example, a credit card, the temporary card can be virtual (e.g., held in a virtual wallet) or simply provision of the unique identifier to the guest (e.g., the guest is given the unique identifier and he or she enters the unique identifier on a number pad at a point-of-sale device). Regardless of the form the temporary card takes, the system provides the temporary card to the guest.

While the discussion of FIG. 1A provides background information regarding providing guest access to a payment method, the discussion of FIG. 1B provides background information regarding use of guest access to a payment method by a guest.

FIG. 1B depicts an overall process of processing a guest payment, according to some embodiments. To use the guest access to the payment method (i.e., the guest payment), the guest 110 presents the temporary card at a point-of-sale device. For example, the guest can present the temporary card by swiping or dipping the temporary card at a card reader of a POS terminal, entering a unique identifier at a user input device of a POS terminal, entering a unique identifier via his or her computing device at a website checkout, etc. When the guest 110 provides the unique identifier, a server 112 verifies the unique identifier. For example, the server 112 can verify the unique identifier by looking up a payment method associated with the unique identifier. In some embodiments, the system provides additional protection by requiring an access number to use the unique identifier. In such embodiments, the server 112 can verify that the access number is correct for the unique identifier.

As previously discussed, the unique identifier can be provided by a financial institution or retailer. If the unique identifier is provided by a financial institution, the server 112 may be operated by the financial institution. In such cases, the point-of-sale device passes the unique identifier, and access number if applicable, to the server 112 for payment processing. If the unique identifier is provided by a retailer, the server 112 can be operated by the retailer. In such cases, the server 112 transmits the payment method associated with the unique identifier to the financial institution for processing of the payment.

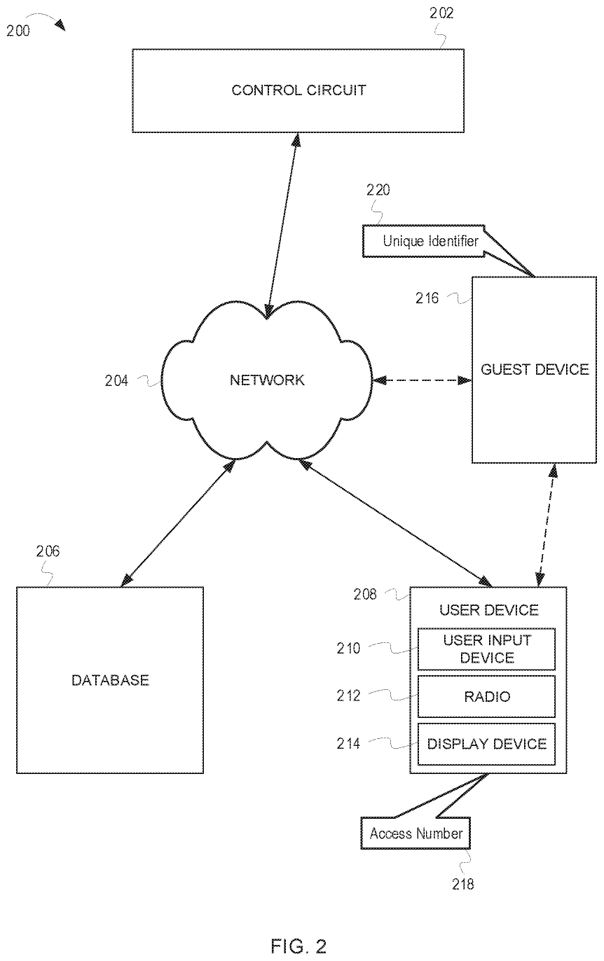

While the discussion of FIGS. 1A and 1B provides background information regarding the assignment and use of guest access to a payment method, the discussion of FIG. 2 provides additional detail regarding such a system.

FIG. 2 is a block diagram of a system 200 for providing guest access to a payment method, according to some embodiments. The system 200 includes a control circuit 202, a database 206, a user device 208, and a guest device 216. The control circuit 202, database 206, and user device 208 are communicatively coupled via a network 204. The network 204 can be of any suitable type, such as a local area network (LAN) and/or wide area network (WAN), such as the Internet, and can include wired and/or wireless links.

The user device 208 allows a user to make a request to create access to a payment method for a guest. Accordingly, the user device 208 can be of any suitable type, such as a computer (e.g., a desktop or laptop computer, a smartphone, a tablet, an automotive infotainment system, etc.). The user device 208 includes a user input device 210 (e.g., a keyboard, trackpad, mouse, joystick, touchscreen, etc.), a communications radio 212, and a display device 214. The user interacts with the user device 208 to create access to a payment method for a guest. When the user creates guest access to a payment method, he or she provides an indication of the payment method (e.g., an identification of a credit card, debit card, gift card, etc.), an indication of the guest (i.e., information sufficient to provide the guest with the information necessary to access the payment method), and, in some embodiments, restrictions for the guest's use of the payment method. The user provides this information to the control circuit 202 via the user device 208.

In some embodiments, the control circuit 202, upon receipt of a request to create guest access to a payment method, verifies the identity of the user. For example, the control circuit 202 can verify the identity of the user based on a series of challenge questions (e.g., prompts, questions, audio matching, etc.). Generally, the control circuit 202 can transmit verification to the user device 208. The user device 208 presents the verification information to the user, for example, via the display device 214, a speaker, etc. The user responds to the verification information to validate his or her identity. For example, if the verification information includes an audible question, the user can respond by typing and/or speaking the answer. It should be noted that in some embodiments, the user may not be explicitly presented with the verification information. For example, if the user's identity is based on voice recognition, the control circuit 202 may process audio spoken by the user to validate the user. The prompt for the verification information in this case may simply be a conversation with the user, as opposed to an explicit prompt for verification information (e.g., “what is your mother's maiden name”).

The control circuit 202 creates a unique identifier 220. The unique identifier 220 is associated with the payment method. For example, the unique identifier can be a code that identifies the payment method (e.g., a pointer, a hash value, etc.). The control circuit 202 updates the database 206 to include the payment method, the unique identifier 220, and an association between the two. The control circuit 202 provides the unique identifier 220 to the guest. For example, the control circuit 202 can transmit the unique identifier 220 to the guest device 216 for storage in a virtual wallet. In embodiments in which the guest is provided with a physical temporary card, the control circuit can transmit the unique identifier 220 to a POS terminal. The POS terminal can write the unique identifier to the physical temporary card.

The control circuit 202 also creates, or receives from the user device 208, an access number 218. The access number 218 is associated with the unique identifier 220 and allows the guest to use the unique identifier 220 to make a payment via the payment method. For example, the access number 218 can be a PIN or other code that the guest uses in connection with the unique identifier 220, much like a PIN is used with a debit card transaction. In one embodiment, the system 200 provides enhanced security by providing the unique identifier 220 and the access number 218 to different devices. For example, the control circuit 202 can transmit the unique identifier 220 to the guest device 216 and the access number to the user device 208. Because the access number 218 is needed to use the unique identifier 220 to make a payment via the payment method, all of the information necessary to use the unique identifier 220 is not provided to a single device. Instead, the user provides the access number 218 to the guest. For example, the user can transmit the access number 218 via the network 204 to the guest device 216 as, for example, text message.

When the guest wishes to make a payment using his or her guest access to the payment method, the guest presents the unique identifier at a point-of-sale device (e.g., in a retail facility, online, over the telephone, etc.). For example, if the unique identifier 220 is stored in a card or virtual wallet, the guest can provide the card or virtual wallet at a POS terminal. In some embodiments, the guest also provides the access number 218. When the guest provides the unique identifier 220, and in some embodiments the access number 218, the control circuit 202 accesses the database 206 to determine with which payment method the unique identifier 220 is associated. The control circuit 202 transmits an indication of the payment method associated with the unique identifier 220 for processing of the payment for the transaction. In embodiments in which the access number 218 is required for use of the unique identifier 220, the control circuit 202 verifies the access number 218 when accessing the database 206. For example, the control circuit 202 may not be able to access the database 206, or the entry for the unique identifier 220 in the database 206, if the access number 218 is incorrect, transmit the indication of the payment method if the access number 218 is incorrect, etc. Further, in some embodiments, the control circuit 202 compares the transaction information with the restriction information to determine whether the unique identifier 220 can be used for the transaction.

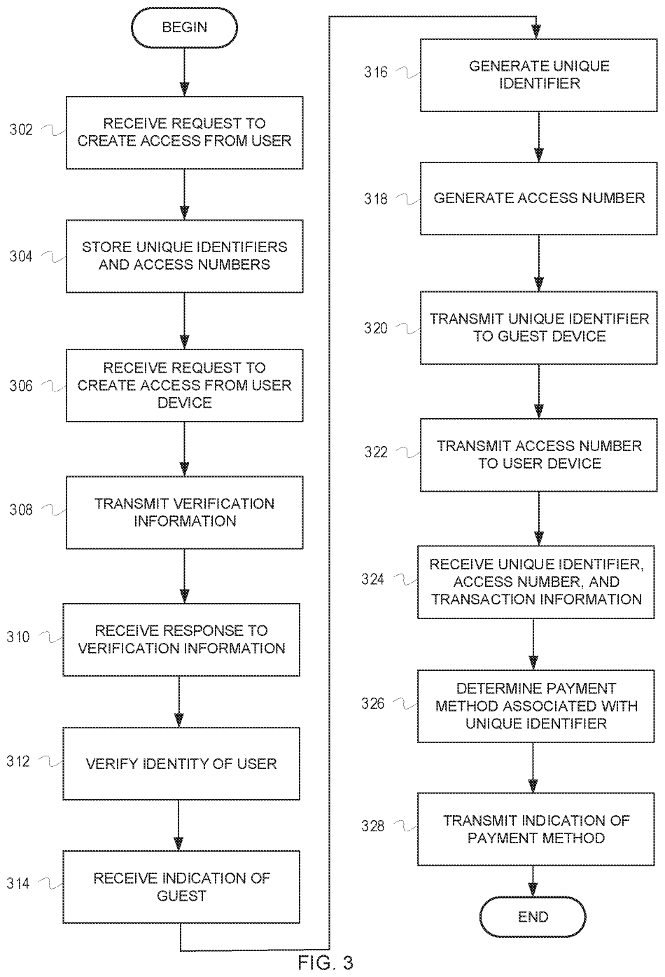

While the discussion of FIG. 2 provides additional information regarding a system for providing guest access to a payment method, the discussion of FIG. 3 describes example operations of such a system.

FIG. 3 is a flow diagram depicting example operation for providing guest access to a payment method, according to some embodiments. The flow begins at block 302.

At block 302, a request to create access to a payment method is received. For example, a user device can receive a request from a user to create guest access to a payment method via a user input device. The user device can be of any suitable type, such as a desktop or laptop computer, mobile device, tablet, etc. The flow continues at block 304.

At block 304, access numbers and unique identifiers are stored. For example, a database can store the access numbers and unique identifiers. The unique identifiers are associated with payment methods. For example, a unique identifier can act as a pointer to a payment method, be associated with a payment method in a table, be a hash value of a payment method, etc. The access numbers, when required, allow use of the unique identifier to process a transaction using the payment method. For example, the access numbers can act as passwords that allow access to the payment methods. The flow continues at block 306.

At block 306, the request to create access to the payment method is received from the user device. For example, the control circuit can receive the request to create access to the payment method from the user device. The flow continues at block 308.

At block 308, verification information is transmitted. For example, the control circuit can transmit verification information to the user device. The verification information can be used to verify the identity of the user and/or that the user is authorized to access the payment method. The verification information can include questions, prompts, requests, etc. For example, the verification information can include security questions. The flow continues at block 310.

At block 310, a response to the verification information is received. For example, the control circuit can receive the response to the verification information from the user device. Continuing the example above, if the verification information includes security questions, the response can include answers to the security questions. The flow continues at block 312.

At block 312, the identity of the user is verified. For example, the control circuit can verify the identity of the user. In some embodiments, the payment method be managed or issued by an entity other than the entity which is providing guest access to the payment method. For example, the payment method may be a credit card issued by a financial institution and a retailer may be providing guest access to the payment method. In such embodiments, the retailer may need to interface with the financial institution to verify the identity of the user. For example, the control circuit may hand the user off to the financial institution's server to complete the verification process. In such embodiments, the verification information is transmitted by the control circuit, responses received by the control circuit, and identification verified by the control circuit in that the control circuit has handed the user off to a third-party system for verification (e.g., the financial institution's system). Alternatively, the entity providing the payment method may be the same entity that is providing guest access to the payment method. For example, a financial institution, retailer, etc. may be both issuing the payment method and providing guest access to the payment method. In either case, the identity of the user is verified based on the verification information and the response to the verification information. Again, continuing the example provided above, the control circuit can verify the identity of the user by determining that the user has answered the security questions correctly. The flow continues at block 314.

At block 314, an indication of a guest is received. For example, the control circuit can receive the indication of the guest from the user device. The guest is the person who will have temporary access to the payment method. The indication of the guest identifies the guest such that the temporary access can be provided. Accordingly, the indication of the guest can include a name, address, birthdate, phone number, email address, etc. of the guest. The flow continues at block 316.

At block 316, a unique identifier is generated. For example, the control circuit can generate the unique identifier. The unique identifier is associated with the payment method. For example, the unique identifier can identify the payment method with which it is associated. In use, the guest presents the unique identifier at a point-of-sale device. The unique identifier is used to determine which payment method should be used for the transaction. The unique identifier can be any suitable type of code, value, pointer, etc. The flow continues at block 318.

At block 318, an access number is generated. For example, the control circuit can generate the access number. The access number acts as a verification and/or security mechanism for the unique identifier. For example, the unique identifier can be a PIN, password, etc. that the guest provides to use the payment method associated with the unique identifier. In some embodiments, the access number is required for use of the unique identifier. For example, the guest may be required to provide the access number for all transactions, transactions over a certain dollar value, transactions including certain items and/or item types, etc. In some embodiments, the guest and/or user can set or otherwise select the access number. In such embodiments, the control circuit generates the access number in that it associates the access number with the unique identifier. The flow continues at block 320.

At block 320, the unique identifier is transmitted to the guest device. For example, the control circuit can transmit the unique identifier to the guest device. The control circuit can transmit the unique identifier to the guest device by transmitting a human-readable code (e.g., a numeric code) via email, text message, etc. and/or transmit a machine-readable code (e.g., a digital card, hash value, etc.) to the guest device. The flow continues at block 322.

At block 322, the access number is transmitted to the user device. For example, the control circuit can transmit the access number to the user device. In embodiments in which the access number is required for use of the unique identifier, the user can provide the guest with the access number. The flow continues at block 324.

At block 324, the unique identifier, access number, and transaction information are received. For example, the control circuit can receive the unique identifier, access number, and transaction information from a point-of-sale device (e.g. a POS terminal). The transaction information is associated with a purchase (e.g., items that the guest would like to purchase, a total transaction amount, taxes, etc.). The control circuit uses the unique identifier, access number, and transaction information to process the transaction via the payment method. The flow continues at block 326.

At block 326, the payment method associated with the unique identifier is determined. For example, the control circuit can determine the payment method that is associated with the unique identifier. As previously discussed, the unique identifier identifies the payment method. The control circuit uses the unique identifier to identify the payment method associated with the unique identifier. The flow continues at block 328.

At block 328, an indication of the payment method is transmitted. For example, the control circuit can transmit the indication of the payment method to a provider of the payment method (e.g., a credit card provider). The control circuit transmits the indication of the payment method and any other information necessary to complete the transaction (e.g., a total cost of the transaction). In such embodiments, transmission of the indication of the payment method occurs in a manner similar to as if a customer had presented the payment method at the point-of-sale device. However, in this case, the unique identifier is presented, the payment method identified based on the unique identifier, and the indication of the payment method is transmitted.

In some embodiments, a system for providing guest access to a payment method comprises a user device, wherein the user device comprises a user input device, wherein the user input device is configured to receive a request from a user to create access to a payment method for a guest, and a display device, wherein the display device is configured to present information to the user, a database, wherein the database is configured to store payment method information, unique identifiers, and access numbers, and a control circuit, wherein the control circuit is communicatively coupled to the user device and the database, the control circuit configured to receive, from the user device, the request to create access to the payment method, transmit, to the user device for presentation via the display device, verification information, receive, from the user device, a response to the verification information, verify, based on the verification information and the response to the verification information, an identity of the user, receive, from the user device, an indication of the guest, generate, based on the indication of the guest and the payment method, a unique identifier, wherein the unique identifier is associated with the payment method, generate, for the unique identifier, an access number, wherein the access number is required for use of the payment method via the unique identifier, transmit, to a guest device, the unique identifier, wherein the guest device is associated with the guest, transmit, to the user device, the access number, receive, from a point-of-sale device, the unique identifier, the access number, and transaction information, wherein the transaction information is associated with a purchase, determine, based on accessing the database, the payment method associated with the unique identifier, and transmit for payment, an indication of the payment method.

In some embodiments, an apparatus and a corresponding method performed by the apparatus comprises receiving, at a user input device of a user device, a request to create access to a payment method for a guest, storing, in a database, payment method information, unique identifiers, and access numbers, receiving, at a control circuit from the user device, the request to create access to the payment method, transmitting, by the control circuit to the user device for presentation on a display device of the user device, verification information, receiving, at the control circuit from the user device, a response to the verification information, verifying, by the control circuit based on the verification information and the response to the verification information, an identity of the user, receiving, from the user device, an indication of the guest, generating, by the control circuit based on the indication of the guest and the payment method, a unique identifier, wherein the unique identifier is associated with the payment method, generating, by the control circuit for the unique identifier, an access number, wherein the access number is required for use of the payment method via the unique identifier, transmitting, by the control circuit to a guest device, the unique identifier, wherein the guest device is associated with the guest, transmitting, by the control circuit to the user device, the access number, receiving, at the control circuit from a point-of-sale device, the unique identifier, the access number, and transaction information, wherein the transaction information is associated with a purchase, determining, by the control circuit based on accessing the database, the payment method associated with the unique identifier, and transmitting for payment, an indication of the payment method.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing guest access to a payment method, the system comprising:
a user device, wherein the user device comprises:
a user input device, wherein the user input device is configured to receive a request from a user to create access to a payment method for a guest; and
a display device, wherein the display device is configured to present information to the user;
a database, wherein the database is configured to store payment method information, unique identifiers, and access numbers; and
a control circuit, wherein the control circuit is communicatively coupled to the user device and the database, the control circuit configured to:
receive, from the user device, the request to create access to the payment method;
transmit, to the user device for presentation via the display device, verification information;
receive, from the user device, a response to the verification information;
verify, based on the verification information and the response to the verification, an identity of the user;
receive, from the user device, an indication of the guest;
generate, based on the indication of the guest and the payment method, a unique identifier, wherein the unique identifier is associated with the payment method;
generate, for the unique identifier, an access number, wherein the access number is required for use of the payment method via the unique identifier;
transmit, to a guest device, the unique identifier, wherein the guest device is associated with the guest;
transmit, to the user device, the access number;
receive, from a point-of-sale device, the unique identifier, the access number, and transaction information, wherein the transaction information is associated with a purchase;
determine, based on accessing the database, the payment method associated with the unique identifier; and
transmit for payment, an indication of the payment method.

2. The system of claim 1, wherein in the payment method is one or more of a credit card, a debit card, and a gift card.

3. The system of claim 1, wherein the point-of-sale device receives the unique identifier from one or more of an in-store transaction and an online transaction.

4. The system of claim 1, wherein the control circuit is further configured to:
receive, from the user device, restriction information, wherein the restriction information indicates restrictions on usage of the unique identifier.

5. The system of claim 4, wherein the control circuit is further configured to:
determine, based on the transaction information and the restriction information, that the unique identifier can be used for the purchase.

6. The system of claim 4, wherein the restrictions are based on one or more of a transaction amount, a temporality of a transaction, a location of a transaction, items included in a transaction, and an occurrence of use of the unique identifier.

7. The system of claim 1, wherein the verification information includes a challenge question and wherein the response to the verification information includes an answer to the challenge question.

8. The system of claim 1, wherein the control circuit is further configured to:
determine, based upon a type of the payment method, that the payment method is eligible for guest access.

9. The system of claim 1, wherein the user device is one or more of a telephone, a smartphone, a computer, and an in-store device.

10. The system of claim 1, wherein the payment method is a credit card, the indication of the payment method is a credit card number associated with the credit card, and wherein the control circuit transmit the indication of the payment method to a credit card provider to complete the purchase.

11. A method for providing guest access to a payment method, the method comprising:
receiving, at a user input device of a user device, a request from a user to create access to a payment method for a guest;
storing, in a database, payment method information, unique identifiers, and access numbers;
receiving, at a control circuit from the user device, the request to create access to the payment method;
transmitting, by the control circuit to the user device for presentation on a display device of the user device, verification information;
receiving, at the control circuit from the user device, a response to the verification information;
verifying, by the control circuit based on the verification information and the response to the verification information, an identity of the user;
receiving, from the user device, an indication of the guest;
generating, by the control circuit based on the indication of the guest and the payment method, a unique identifier, wherein the unique identifier is associated with the payment method;
generating, by the control circuit for the unique identifier, an access number, wherein the access number is required for use of the payment method via the unique identifier;
transmitting, by the control circuit to a guest device, the unique identifier, wherein the guest device is associated with the guest;
transmitting, by the control circuit to the user device, the access number;
receiving, at the control circuit from a point-of-sale device, the unique identifier, the access number, and transaction information, wherein the transaction information is associated with a purchase;
determining, by the control circuit based on accessing the database, the payment method associated with the unique identifier; and
transmitting for payment, an indication of the payment method.

12. The method of claim 11, wherein the payment method is one or more of a credit card, a debit card, and a gift card.

13. The method of claim 11, wherein the point-of-sale device receives the unique identifier from one or more of an in-store transaction and an online transaction.

14. The method of claim 11, further comprising:
receiving, from the user device, restriction information, wherein the restriction information indicates restrictions on usage of the unique identifier.

15. The method of claim 14, further comprising:
determining, by the control circuit based on the transaction information and the restriction information, that the unique identifier can be used for the purchase.

16. The method of claim 14, wherein the restrictions are based on one or more of a transaction amount, a temporality of a transaction, a location of a transaction, items included in a transaction, and an occurrence of use of the unique identifier.

17. The method of claim 11, wherein the verification information includes a challenge question and wherein the response to the verification information includes an answer to the challenge question.

18. The method of claim 11, further comprising:
determining, based upon a type of the payment method, that the payment method is eligible for guest access.

19. The method of claim 11, wherein the user device is one or more of a telephone, a smartphone, a computer, and an in-store device.

20. The method of claim 11, wherein the payment method is a credit card, wherein the indication of the payment method is a credit card number associated with the credit card, and wherein the control circuit transmits the indication of the payment method to a credit card provider to complete the purchase.
